(19) United States
(12) Patent Application Publication
(10) Pub. No.: US 2013/0034685 A1
(43) Pub. Date: Feb. 7, 2013

(54) DISPLAY DEVICE AND METHOD FOR MANUFACTURING THE SAME

(71) Applicants: Cheol-Geun An, Yongin-city (KR); Sang-Hyun Lim, Yongin-city (KR)

(72) Inventors: Cheol-Geun An, Yongin-city (KR); Sang-Hyun Lim, Yongin-city (KR)

(21) Appl. No.: 13/429,281

(22) Filed: Mar. 23, 2012

(30) Foreign Application Priority Data
Aug. 2, 2011 (KR) 10-2011-0077109

(51) Int. Cl. B32B 3/02; B32B 38/00

(52) U.S. Cl. 428/121; 156/222

(57) ABSTRACT

A display device includes a flexible display panel for displaying an image, a flexible functional plate on the flexible display panel, and a thermosetting resin layer between the flexible display panel and the flexible functional plate, wherein the thermosetting resin layer is cured while the flexible display panel and the flexible functional plate are bent.

### CROSS-REFERENCE TO RELATED APPLICATION

This application claims priority to and the benefit of Korean Patent Application No. 10-2011-0077109 filed in the Korean Intellectual Property Office on Aug. 2, 2011, the entire content of which is incorporated herein by reference.

### BACKGROUND

1. Field

The described technology relates generally to a display device.

2. Description of Related Art

Recently, a lightweight display device having a shock-resistant flexible substrate made of a material such as plastic has been developed. Such a display device includes a flexible display panel having a flexible substrate and a display element formed on the flexible substrate, and can be utilized in various fields because it can be used in the bent or curved state.

Display elements that can be used in the flexible display panel include an organic light emitting diode display element, a liquid crystal display element, and an electrophoretic display (EPD) element.

In addition, the display device may further include a functional plate, such as a touch screen panel or a protection window. Such a functional plate is bonded to the flexible display panel and the two are then bent together.

However, when the display device is bent, tension is generated in the flexible display panel and the functional plate toward a direction in which the flexible display panel and the functional plate tend to spread flat. When the tension is stronger than a bonding force between the flexible display panel and the functional plate, the flexible display panel and the functional plate may separate from each other, causing a failure.

The above information disclosed in this Background section is only for enhancement of understanding of the background of the described technology and therefore it may contain information that does not form the prior art that is already known in this country to a person of ordinary skill in the art.

### SUMMARY

Embodiments of the present invention provide a display device including a flexible display panel that can be stably bent.

A display device according to an exemplary embodiment includes a flexible display panel for displaying an image, a flexible functional plate on the flexible display panel, and a thermosetting resin layer between the flexible display panel and the flexible functional plate, wherein the thermosetting resin layer is cured while the flexible display panel and the flexible functional plate are bent.

The flexible functional plate may be at least one selected from the group consisting of a polarizing plate, a touch screen panel, and a protection window.

The display device may further include one or more additional flexible functional plates on the flexible display panel, and an additional thermosetting resin layer between the flexible display panel and the one or more additional flexible functional plate.

The thermosetting resin layer and the additional thermosetting resin layer may be contracted while being cured.

The thermosetting resin layer may be at an inner side of a direction to which the flexible display panel and the flexible functional plate are curved, the additional thermosetting resin layer may be at an outer side of the direction, and the thermosetting resin layer maybe further contracted than the additional thermosetting resin layer.

The thermosetting resin layer may bond the flexible display panel to the flexible functional plate.

The thermosetting resin layer may provide a reaction force for opposing tension generated from bending the flexible display panel and the flexible functional plate.

According to another exemplary embodiment, a manufacturing method of a display device is provided. The manufacturing method of the display device includes preparing a flexible display panel configured to display an image, placing a thermosetting resin layer on the flexible display panel, placing a flexible functional plate on the thermosetting resin layer, bending the flexible display panel and the flexible functional plate with the thermosetting resin layer therebetween, and curing the thermosetting resin layer while bending the flexible display panel and the flexible functional plate.

The flexible functional plate may be at least one selected from the group consisting of a polarizing plate, a touch screen panel, and a protection window.

The method may further include placing an additional flexible functional plate on the flexible display panel, and placing an additional thermosetting resin layer between the additional flexible functional plate and the flexible functional plate.

The method may further include contracting the thermosetting resin layer and the additional thermosetting resin layer while curing the thermosetting resin layer and the additional thermosetting resin layer.

The thermosetting resin layer or the additional thermosetting resin layer may be located at an inner side of a direction to which the flexible display panel and the flexible functional plate are curved and may be further contracted than the other of the thermosetting resin layer or the additional thermosetting resin layer that is located at an outer side of the direction.

The thermosetting resin may bond the flexible display panel and the flexible functional plate to each other.

The thermosetting resin layer may provide a reaction force for opposing tension generated from the bending the flexible display panel and the flexible functional plate.

According to the exemplary embodiments, the display device may include a flexible display panel that can be stably bent.

### BRIEF DESCRIPTION OF THE DRAWINGS

FIG. 1 is a cross-sectional view of a display device according to an exemplary embodiment of the present invention.

FIG. 2 and FIG. 3 are cross-sectional views corresponding to a manufacturing process of the display device of the embodiment shown in FIG. 1.

### DETAILED DESCRIPTION

Embodiments of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The drawings are schematic and not necessarily drawn to scale. Relative scales and ratios in the drawings may be enlarged or reduced for the purpose of convenience, and the scales may be random and not limited thereto. In addition, like reference numerals designate like structures, elements, or parts throughout the specification. It will be understood that when an element is referred to as being “on” another element, it can be directly on another element or one or more intervening elements may be present therebetween.

Embodiments of the present invention described with reference to cross-sectional views represent exemplary embodiments in detail. Therefore, various modifications of diagrams are expected. Accordingly, exemplary embodiments of the present invention are not limited to specific shapes of shown regions, and may also include modifications of the shape by manufacturing.

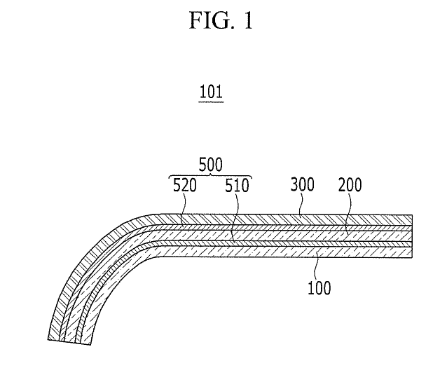

Hereinafter, a display device 101 according to an exemplary embodiment of the present invention will be described with reference to FIG. 1.

As shown in FIG. 1, the display device 101 according to the present exemplary embodiment includes a flexible display panel 100, functional plates 200 and 300, and a thermosetting resin layer 500.

The flexible display panel 100 includes a display element located on a flexible substrate made of a material such as, for example, plastic. The display element may be one of, for example, an organic light emitting diode display element, a liquid crystal display element, and an electrophoretic display (EPD) element. Such a display element may have various structures, as will be known to a person skilled in the art.

The functional plates 200 and 300 are located on the flexible display panel 100 and made of a flexible material. That is, the functional plates 200 and 300 may be bent along with the flexible display panel 100.

The functional plates 200 and 300 may be at least one of, for example, a polarizing plate, a touch screen panel, or a protection window.

In addition, two or more functional plates 200 and 300 may be located on the flexible display panel 100, according to embodiments of the present invention, and as few as one functional plate may be located on the flexible display panel of other embodiments of the present invention.

In FIG. 1, the touch screen panel 200 and the protection window 300 are the functional plates 200 and 300 on the flexible display panel 100. However, the present exemplary embodiment is not limited thereto, and a polarizing plate (not shown) and the protection window 300, the polarizing plate and the touch screen panel 200, or the polarizing plate, the touch screen panel 200, and the protection window (300) may be located on the flexible display panel 100.

The thermosetting resin layer 500 may be located between the flexible display panel 100 and the functional plates 200 and 300 (e.g., first thermosetting resin layer 510) and between the functional plates 200 and 300 (e.g., second thermosetting resin layer 520).

Hereinafter, the portion of the thermosetting resin layer 500 located between the flexible display panel 100 and the touch screen panel 200 is referred to as a first thermosetting resin layer 510, and the portion of the thermosetting resin layer 500 located between the touch screen panel 200 and the protection window 300 is referred to as a second thermosetting resin layer 520.

The first thermosetting resin layer 510 bonds the flexible display panel 100 to the touch screen panel 200, and the second thermosetting resin layer 520 bonds the touch screen panel 200 to the protection window 300.

The first thermosetting resin layer 510 and the second thermosetting resin layer 520 may be cured by heat or ultraviolet (UV) ray. Here, the first thermosetting resin layer 510 and the second thermosetting resin layer 520 are cured while the flexible display panel 100, the touch screen panel 200, and the protection window 300 are in a bent state. Thus, the first thermosetting resin layer 510 and the second thermosetting resin layer 520 provide a reaction force against, or opposing, tension generated by the bending of the flexible display panel 100, the touch screen panel 200, and the protection window 300 (e.g., the tension toward a direction that the flexible display panel and the functional plate tend to spread flat). That is, the first thermosetting resin layer 510 and the second thermosetting resin layer 520 prevent, or reduce the likelihood of, the flexible display panel 100, the touch screen panel 200, and the protection window 300, which are bonded to each other, from being separated from each other due to the tension generated by the bending of the flexible display panel 100, the touch screen panel 200, and the protection window 300.

Further, the first thermosetting resin layer 510 and the second thermosetting resin layer 520 are contracted while being cured. The contraction force of the first and second thermosetting resin layers 510 and 520 reinforce the reaction force against the tension generated by the bending of the flexible display panel 100, the touch screen panel 200, and the protection window 300, so that the tension generated by the bending can be effectively offset.

In addition, the thermosetting resin layer 500 located at an inner side (e.g., the first thermosetting resin layer 510) with reference to a direction that the flexible display panel 100, the touch screen panel 200, and the protection window 300 are curved is contracted more than the thermosetting resin layer 500 located at an outer side (e.g., the second thermosetting resin layer 520) with reference to the curved direction. In further detail, and as shown in FIG. 1, when the flexible display panel 100 becomes the concave inner side, and when the protection window 300 becomes the convex outer side, the contraction force of the first thermosetting resin layer 510 located between the flexible display panel 100 and the touch screen panel 200 is set to be stronger than that of the second thermosetting resin layer 520 located between the touch screen panel 200 and the protection window 300. Such a contraction force difference may be controlled by, for example, changing the characteristic of the thermosetting resin layers 500 or changing a curing method.

As described, the contraction force of the first thermosetting resin layer 510 located at the inner side of the curved direction is set to be stronger than that of the second thermosetting resin layer 520 located at the outer side, so that a contraction force difference can act as the reaction force against the tension. Accordingly, the reaction force against the tension generated by the bending of the flexible display panel 100, the touch screen panel 200, and the protection window 300 can be further effectively reinforced through the first thermosetting resin layer 510 and the second thermosetting resin layer 520.

With such a configuration, the display device 101 can be stably bent and while stably maintaining the bent state.

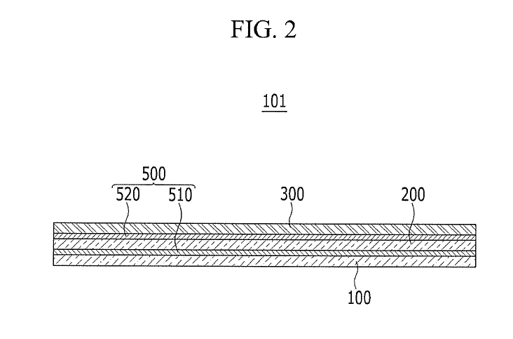

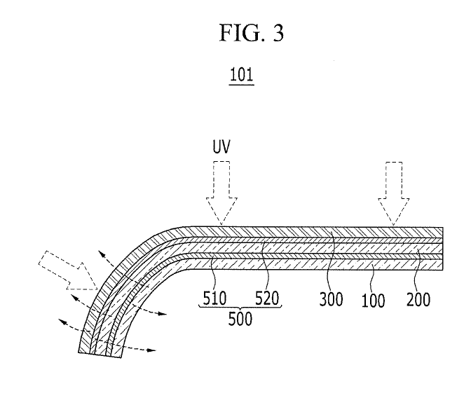

Hereinafter, a manufacturing method of a display device 101 according to an embodiment of the present invention will be described in further detail with reference to FIG. 2 and FIG. 3.

First, as shown in FIG. 2, a flexible display panel 100 for displaying an image is prepared. The flexible display panel 100 may be formed by forming, for example, a display element from the group of an organic light emitting diode display element, a liquid crystal display element, and an electrophoretic display (EPD) element on a flexible substrate made of a material such as, for example, plastic.

Next, a first thermosetting resin layer 510 is located on the flexible display panel 100. Then, a touch screen panel 200 is located on the first thermosetting resin layer 510. Here, the first thermosetting resin layer 510 causes the flexible display panel 100 and the touch screen panel 200 to be bonded to each other.

In addition, in the present exemplary embodiment, various types of touch screen panels known to a person skilled in the art may be used as the touch screen panel 200. Like the flexible display panel 100, the touch screen panel 200 may be formed to be flexible.

Next, a second thermosetting resin layer 520 is located on the touch screen panel 200. In addition, a protection window 300 is located on the second thermosetting resin layer 520. The protection window 300 is made of a transparent material, and is formed to be flexible like the flexible display panel 100 and the touch screen panel 200.

Next, as shown in FIG. 3, the flexible display panel 100, the touch screen panel 200, and the protection window 300 are bent with the first thermosetting resin layer 510 and the second thermosetting resin layer 520 respectively interposed therebetween. In FIG. 3, the display device is bent in such a way that the flexible display panel 100 becomes a concave inner side, and the protection window 300 becomes a convex outer side, but the exemplary embodiment is not limited thereto. Thus, the flexible display panel 100, the touch screen panel 200, and the protection window 300 may be bent to a direction that is opposite to the direction shown in FIG. 3.

Next, the first thermosetting resin layer 510 located between the flexible display panel 100 and the touch screen panel 200 and the second thermosetting resin layer 520 located between the touch screen panel 200 and the protection window 300 are cured. In this case, the first thermosetting resin layer 510 and the second thermosetting resin layer 520 may be cured by heat or ultraviolet (UV) ray.

When being cured, the first thermosetting resin layer 510 and the second thermosetting resin layer 520 produce a reaction force against tension generated by the bending of the flexible display panel 100, the touch screen panel 200, and the protection window 300 (e.g., a tension opposing the bending). That is, the first thermosetting resin layer 510 and the second thermosetting resin layer 520 are cured while being curved to decrease the likelihood of the flexible display panel 100, the touch screen panel 200, and the protection window 300 that are bonded to each other are separated from each other by the tension generated by the bending of the flexible display panel 100, the touch screen panel 200, and the protection window 300.

Further, the first thermosetting resin layer 510 and the second thermosetting resin layer 520 are contracted while being cured. A contraction force of the first thermosetting resin layer 510 located at an inner side of the curved direction is stronger than that of the second thermosetting resin layer 520 located at an outer side of the curved direction (e.g., to compensate for the different degrees of tension caused by the bending at areas respectively corresponding to the first and second thermosetting resin layers 510 and 520). As described, since the contraction force of the first thermosetting resin layer 510 located at an inner side of the curved direction and the contraction force of second thermosetting resin layer 520 located at an outer side of the curved direction are set to be different from each other, the reaction force against the tension generated by the bending of the flexible display panel 100, the touch screen panel 200, and the protection window 300 may be effectively reinforced so that the tension can be offset. The contraction force difference between the first thermosetting resin layer 510 and the second thermosetting resin layer 520 can be controlled by changing characteristics thereof or by changing a curing method.

FIG. 2 and FIG. 3 illustrate that the display device 101 includes the touch screen panel 200 and the protection window 300, but the exemplary embodiment is not limited thereto. Thus, the display device 101 may include a polarizing plate (not shown) rather than the touch screen panel 200 or the protection window 300, or may include all of them. Further, the display device 101 may further include a third thermosetting resin layer.

With such a manufacturing method, the display device 101 according to the exemplary embodiment can be manufactured. That is, the display device 101 can be manufactured to be stably bent and to stably maintain the bent state.

Further, according to the present exemplary embodiment, the shape of the display device 101 can be fixed because the thermosetting resin layer 500 is cured after the display device 101 is bent, and therefore the display device 101 can be bent in various shapes and the shape can be effectively maintained.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and their equivalents.

Description of Some of the Reference Characters

| | |
|---|---|
| 100: flexible display panel | 101: display device |
| 200: touch screen panel | 300: protection window |
| 500: thermosetting resin layer | 510: first thermosetting resin layer |
| 520: second thermosetting resin layer | |

What is claimed is:

1. A display device comprising:
a flexible display panel for displaying an image;
a flexible functional plate on the flexible display panel; and
a thermosetting resin layer between the flexible display panel and the flexible functional plate,
wherein the thermosetting resin layer is cured while the flexible display panel and the flexible functional plate are bent.

2. The display device of claim 1, wherein the flexible functional plate is at least one selected from the group consisting of a polarizing plate, a touch screen panel, and a protection window.

3. The display device of claim 2, further comprising:
one or more additional flexible functional plates on the flexible display panel; and
an additional thermosetting resin layer between the flexible display panel and the one or more additional flexible functional plate.

4. The display device of claim 3, wherein the thermosetting resin layer and the additional thermosetting resin layer are contracted while being cured.

5. The display device of claim 4, wherein the thermosetting resin layer is at an inner side of a direction to which the flexible display panel and the flexible functional plate are curved, wherein the additional thermosetting resin layer is at an outer side of the direction, and wherein the thermosetting resin layer is further contracted than the additional thermosetting resin layer.

6. The display device of claim 1, wherein the thermosetting resin layer bonds the flexible display panel to the flexible functional plate.

7. The display device of claim 1, wherein the thermosetting resin layer provides a reaction force for opposing tension generated from bending the flexible display panel and the flexible functional plate.

8. A manufacturing method of a display device, the method comprising:
preparing a flexible display panel configured to display an image;
placing a thermosetting resin layer on the flexible display panel;
placing a flexible functional plate on the thermosetting resin layer;
bending the flexible display panel and the flexible functional plate with the thermosetting resin layer therebetween; and
curing the thermosetting resin layer while bending the flexible display panel and the flexible functional plate.

9. The manufacturing method of the display device of claim 8, wherein the flexible functional plate is at least one selected from the group consisting of a polarizing plate, a touch screen panel, and a protection window.

10. The manufacturing method of the display device of claim 9, further comprising:
placing an additional flexible functional plate on the flexible display panel; and
placing an additional thermosetting resin layer between the additional flexible functional plate and the flexible functional plate.

11. The manufacturing method of the display device of claim 10, further comprising contracting the thermosetting resin layer and the additional thermosetting resin layer while curing the thermosetting resin layer and the additional thermosetting resin layer.

12. The manufacturing method of the display device of claim 11, wherein the thermosetting resin layer or the additional thermosetting resin layer is located at an inner side of a direction to which the flexible display panel and the flexible functional plate are curved and is further contracted than the other of the thermosetting resin layer or the additional thermosetting resin layer that is located at an outer side of the direction.

13. The manufacturing method of the display device of claim 8, wherein the thermosetting resin bonds the flexible display panel and the flexible functional plate to each other.

14. The manufacturing method of the display device of claim 8, wherein the thermosetting resin layer provides a reaction force for opposing tension generated from the bending the flexible display panel and the flexible functional plate.
